(19) United States
(12) Patent Application Publication
(10) Pub. No.: US 2021/0178280 A1
(43) Pub. Date: Jun. 17, 2021

(54) LIGHTING MODULE OF ASSEMBLABLE TOY

(71) Applicant: WBStudio Technology Media CO., LTD., Taoyuan City (TW)

(72) Inventor: Haw-Yeu WU, Taoyuan City (TW)

(73) Assignee: WBStudio Technology Media CO., LTD., Taoyuan City (TW)

(21) Appl. No.: 16/717,276

(22) Filed: Dec. 17, 2019

(51) Int. Cl. A63H 33/04; A63H 33/22; F21V 23/00; F21S 9/02

(52) U.S. Cl. CPC A63H 33/042; F21S 9/02; F21V 23/007; A63H 33/22

(57) ABSTRACT

An assemblable toy has two bricks, a main base and an illuminating piece. Multiple light connectors are mounted on the main base. A power supply unit is mounted on the main base and electrically connected to the light connectors. An illuminating piece is selectively connected to one of the light connectors, and has a flexible flat cable, a plug, and an illuminating portion. The plug and the illuminating portion are mounted on opposite ends of the flexible flat cable and electrically connected to each other. The plug is electrically connected to the corresponding light connector. The flexible flat cable passes through a clearance between the two bricks without affecting ease of assembly and proper external appearance of the toy. The illuminating piece can be integrated into most of the standard plastic assemblable toys to provide decorative lighting.

### BACKGROUND OF THE INVENTION

### 1. Field of the Invention

The present invention relates to a lighting module, especially to a lighting module of an assemblable toy.

### 2. Description of the Prior Arts

Conventional LEGO® sets or plastic assemblable toys can be assembled in different ways to form different models or patterns according to creativity of a user, and the user can modify color of an assembled model as well. However, most of the LEGO® sets or the plastic assemblable toys lack decorative lighting. Decorative lighting can only be found on high-end assemblable toys, such as assemblable car models or robot models. An exclusive lighting module is further integrated into the high-end assemblable toy to generate decorative lighting which improves visual effect for the assembled toy. Besides, the LEGO® set or the plastic assemblable toy without exclusive lighting module can be modified by a skilled user to integrate wires and lighting components to provide decorative lighting.

However, taking the LEGO® set for example, said exclusive lighting module can only be installed in the high-end LEGO® set which has dedicated wiring space and mounting space reserved for the lighting module, and hence cannot be installed properly in a standard LEGO® set due to lack of wiring space. Integrating the exclusive lighting module into the standard Logo is either impossible or creates excessive gaps on the assembled model, which causes inconvenience to the user and affects external appearance of the products.

Although the standard LEGO® set can be modified by the skilled user to integrate the wires and the lighting components to provide decorative lighting, it is a highly time-consuming task. Besides, the wires often break during the assembling process, and quality of soldering is also unstable.

To overcome the shortcomings, the present invention provides a lighting module of an assemblable toy to mitigate or obviate the aforementioned problems.

### SUMMARY OF THE INVENTION

The main objective of the present invention is to provide a lighting module of an assemblable toy, wherein an illuminating piece of the lighting module has a flexible flat cable which is able to pass through clearance between adjacent bricks of an assembled standard LEGO® set or that of an assembled standard plastic assemblable toy. Therefore, the illuminating piece can be integrated into most of the standard LEGO® sets and the standard plastic assemblable toys to provide decorative lighting while maintaining ease of assembly and proper external appearance of the products.

The lighting module of an assemblable toy has a main base and an illuminating piece. The main base has a top surface, a bottom surface, multiple light connectors and a power supply. The light connectors are mounted on the top surface of the main base, and each one of the light connectors has a socket. A power supply unit is mounted on the bottom surface of the main base and electrically connected to the light connectors. The illuminating piece is selectively connected to one of the light connectors, and has a flexible flat cable, a plug and an illuminating portion. The flexible flat cable is a flexible printed circuit. The plug is mounted on one of two ends of the flexible flat cable, engaged with the socket of the corresponding light connector, and electrically connected to the corresponding light connector. The illuminating portion is electrically connected to the other end of the flexible flat cable and is capable of emitting light.

The advantage of the present invention is that the illuminating piece has the flexible flat cable which is able to pass through the clearance between the adjacent bricks of the assembled standard LEGO® set or that of the assembled standard plastic assemblable toy. Therefore, the illuminating piece can be integrated into most of the standard LEGO® sets and the standard plastic assemblable toys to provide decorative lighting while maintaining ease of assembly and proper external appearance of the products.

The lighting module of an assemblable toy further comprises a power connecting unit adapted to be electrically connected to an external power source and the light connectors. Because the present invention can be powered by the external power source using the power connecting unit, the present invention can provide continuous light exhibition as long as the external power source continuously supplies electricity.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a lighting module of an assemblable toy in accordance with the present invention;

FIG. 2 is an exploded view of the lighting module of an assemblable toy in FIG. 1;

FIG. 3 is a top view of a second embodiment of a lighting module of an assemblable toy in accordance with the present invention; and

FIG. 4 is a top view of the lighting module of an assemblable toy in FIG. 1 installed in a LEGO® car.

### DETAILED DESCRIPTION OF THE PREFERRED EMBODIMENTS

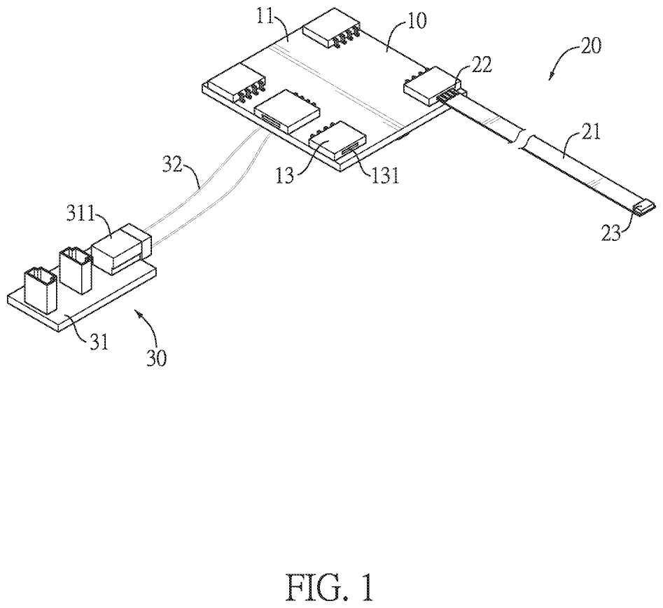

With reference to FIG. 1, a lighting module of an assemblable toy in accordance with the present invention comprises a main base 10 and an illuminating piece 20, and in a preferred embodiment, the lighting module further comprises a power connecting unit 30.

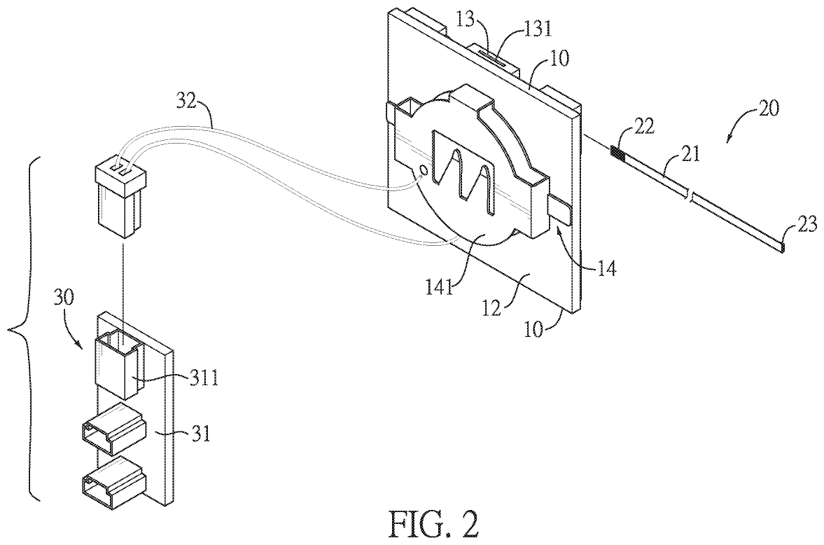

With reference to FIGS. 1 and 2, the main base 10 is a printed circuit board (PCB) having electric circuit for conducting electricity. The main base 10 has a top surface 11, a bottom surface 12, multiple light connectors 13, and a power supply unit 14. The light connectors 13 are mounted on the top surface 11 of the base. Each one of the light connectors 13 has a socket 131. An end of each one of the sockets 131 is electrically connected to the electric circuit of the main base 10. In a preferred embodiment, an opening of the socket 131 of each one of the light connectors 13 is toward a direction away from a center of the main base 10, but the direction of the openings of the sockets 131 is not limited thereto, and can be modified according to the need of a user.

The power supply unit 14 is mounted on the bottom surface 12 of the main base 10. The power supply unit 14 has a battery mount 141. The battery mount 141 is adapted to clamp and electrically connect to a battery (not shown in figures). The battery mount 141 is electrically connected to the electric circuit of the main base 10 to conduct electricity of said battery to each light connector 13.

The illuminating piece 20 is selectively connected to one of the light connectors 13, and has a flexible flat cable 21, a plug 22, and an illuminating portion 23. The flexible flat cable 21 is a flexible printed circuit (FPC) with a thickness smaller than a clearance of any two adjacent LEGO® blocks or any two adjacent blocks of a plastic assemblable toy (not shown in figures). The plug 22 is mounted on one of two ends of the flexible flat cable 21, engaged with the socket 131 of the corresponding light connector 13, and electrically connected to the corresponding light connector 13 via the socket 131.

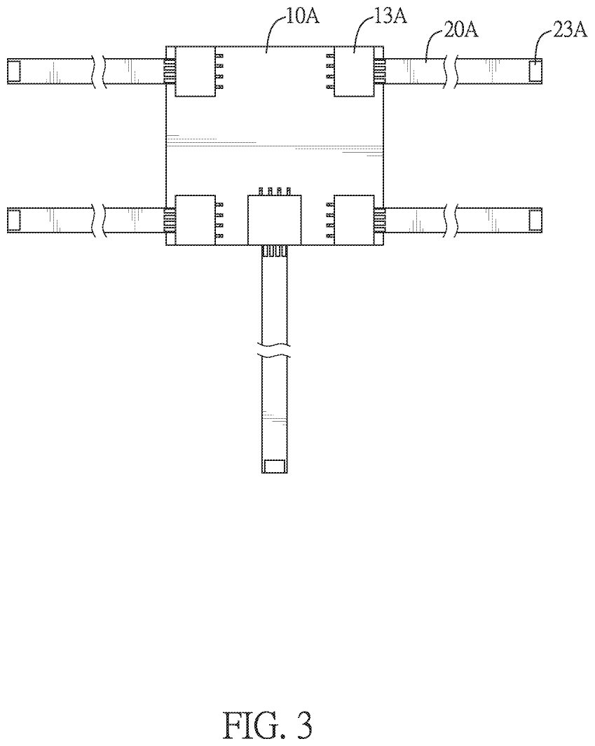

The illuminating portion 23 is a light emitting diode (LED), and is electrically connected to the other end of the flexible flat cable 21. The illuminating portion 23 is powered by the power supply unit 14 via the socket 131 and generates light. With reference to FIG. 3, in another preferred embodiment, there can be multiple illuminating pieces 20A. Each one of the illuminating pieces 20A is connected to a respective one of the light connectors 13A to light up multiple all illuminating portions 23A at the same time.

The power connecting unit 30 comprises a connecting base 31 and a connecting cord 32. The connecting base 31 is a printed circuit board (PCB) having electric circuit for conducting electricity. Multiple power connectors 311 are mounted on one side of the connecting base 31. The power connectors 311 are electrically connected with each other via the electric circuit of the connecting base 31. One of the power connectors 311 is adapted to electrically connect to an external power source (not shown in figures) to conduct electricity of said external power source to the power connectors 311. Another one of the power connectors 311 is electrically connected to the connecting cord 32.

Two ends of the connecting cord 32 are electrically connected to the power supply unit 14 and said power connector 311 respectively. As a result, the illuminating portion 23 can be powered alternatively by the external power source via the power connector 311 and the connecting cord 32 of the power connecting unit 30. In the preferred embodiment, a number of the power connectors 311 is three, meaning that the power connecting unit 30 is capable of connecting the illuminating portion 23 with two external batteries simultaneously to increase operating time.

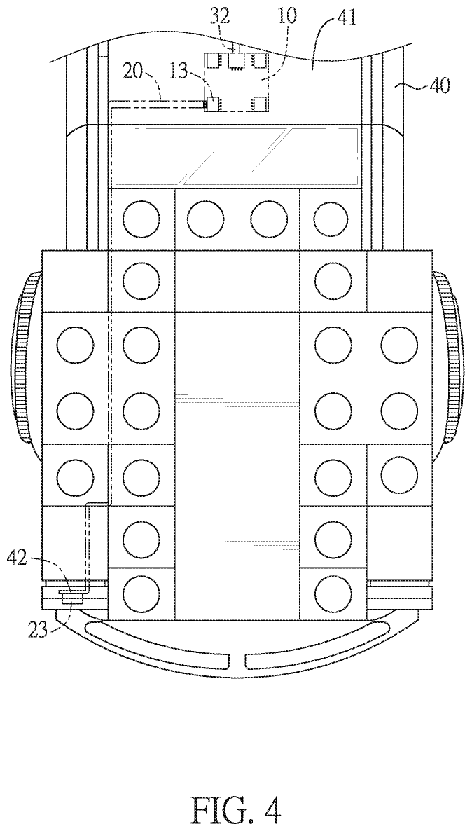

With reference to FIG. 4, the present invention can be installed in a LEGO® car 40. The LEGO® car 40 has a driving seat 41 and a headlight 42.

To power up the present invention with the battery, the user inserts the battery into the battery mount 141, and then inserts the plug 22 of the illuminating piece 20 into the socket 131 of one of the light connectors 13 that is in the most suitable location for the plug 22. The main base 10 can be mounted in a space of the driving seat 41. The flexible flat cable 21 passes through clearance between adjacent bricks and extend to an inner space of the headlight 42. Finally, the illuminating portion 23 is mounted inside the headlight.

To power up the present invention with the external power source, leave the battery uninstalled, and electrically connect the external power source to one of the power connectors 311 of the power connecting unit 30. Finally, electrically connect the power connecting unit 30 to the power supply unit 14 using the connecting cord 32 to conduct the electricity of the external power source to the power supply unit 14.

In summary, the illuminating piece 20 has a flexible flat cable 21 which is able to pass through the clearance between adjacent bricks, thereby maintaining ease of assembly and proper external appearance of the products. As a result, the illuminating piece 20 can be integrated into most of the standard LEGO® sets and the standard plastic assemblable toys to provide decorative lighting while maintaining ease of assembly and proper external appearance of the products.

Additionally, because a plurality of the light connectors 13 are mounted on the main base 10, multiple said main bases 10 can be electrically connected together using the light connectors 13, thereby increasing total amount of the light connectors 13 on the main bases 10. As a result, an amount of the illuminating pieces 20 that the present invention can connect is increased. A capacity of the present invention can be expanded thereby.

Besides, because the present invention can be powered by an external power source using power connecting unit 30, the present invention can provide continuous light exhibition as long as the external power source continuously supplies electricity.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. An assemblable toy, comprising:
two bricks adjacent to each other;
a main base having
a top surface;
a bottom surface;
multiple light connectors mounted on the top surface of the main base, each one of the light connectors having a socket; and
a power supply unit mounted on the bottom surface of the main base and electrically connected to the light connectors; and
an illuminating piece selectively connected to one of the light connectors, and having
a flexible flat cable being a flexible printed circuit and passing through a clearance between the two bricks;
a plug mounted on one of two ends of the flexible flat cable, engaged with the socket of the corresponding light connector, and electrically connected to the corresponding light connector; and
one single illuminating portion electrically connected to the other end of the flexible flat cable and being capable of emitting light, wherein
no electrically connected object is disposed between said one single illuminating portion and the plug.

2. The assemblable toy as claimed in claim 1, further comprising a power connecting unit adapted to be electrically connected to an external power source and the light connectors.

3. The assemblable toy as claimed in claim 2, wherein the power connecting unit comprises
a connecting base;
multiple power connectors mounted on one side of the connecting base and electrically connected with each other; and
a connecting cord electrically connected to the power supply unit, wherein
one of the power connectors is adapted to be electrically connected to the external power source, and another one of the power connectors is electrically connected to the connecting cord.

4. The assemblable toy as claimed in claim 1, wherein an opening of the socket of each one of the light connectors is toward a direction away from a center of the main base.

5. The assemblable toy as claimed in claim 3, wherein an opening of the socket of each one of the light connectors is toward a direction away from a center of the main base.

6. The assemblable toy as claimed in claim 1, wherein
the power supply unit further has a battery mount; and
the battery mount is adapted to clamp and to be electrically connected to a battery.

7. The assemblable toy as claimed in claim 5, wherein
the power supply unit further has a battery mount; and
the battery mount is adapted to clamp and to be electrically connected to a battery.

8. The assemblable toy as claimed in claim 1, wherein the illuminating portion is a light emitting diode.

9. The assemblable toy as claimed in claim 7, wherein the illuminating portion is a light emitting diode.

10. The assemblable toy as claimed in claim 1, wherein the main base is a printed circuit board.

11. The assemblable toy as claimed in claim 9, wherein the main base and the connecting base of the power connecting unit are printed circuit boards.
